(19) United States
(12) Patent Application Publication
(10) Pub. No.: US 2024/0232884 A1
(43) Pub. Date: Jul. 11, 2024

(54) TRANSFORMING RESOURCES BETWEEN CENTRALIZED AND DECENTRALIZED NETWORKS

(71) Applicant: Truist Bank, Charlotte, NC (US)

(72) Inventor: Barath Jayaraman, Fort Mill, SC (US)

(73) Assignee: Truist Bank, Charlotte, NC (US)

(21) Appl. No.: 18/151,658

(22) Filed: Jan. 9, 2023

(51) Int. Cl. G06Q 20/40; G06Q 20/38

(52) U.S. Cl. CPC G06Q 20/4014; G06Q 20/38215; G06Q 20/3829

(57) ABSTRACT

A system for transforming a resource from a first type into a second type. The system receives login credentials and a request for remote access to a user account associated with an entity utilizing a centralized network. The system authenticates the login credentials and grants access to the user account. The system receives a unique identifier for a first type of electronic digital certificate resource associated with a decentralized ledger and stores a record of it. Once the system receives a request to initiate an interaction between the decentralized ledger and the user account, the system determines a balance of the first type of resource on the decentralized ledger using the stored record of the unique identifier. The system transforms the resource from the first type to a second type and completes the requested interaction between the decentralized ledger and the user account.

### FIELD

This invention is related generally to the field of cryptocurrency exchange and more particularly embodiments of the invention relate to the buying and trading of cryptocurrency absent a traditional cryptocurrency exchange network.

### BACKGROUND OF THE INVENTION

Digital currencies or assets, such as Bitcoin and Ethereum, are generated using distributed ledger technology (DLT) within one or more decentralized computing systems. These decentralized computing systems are typically incorporated into a complicated ecosystem online and may be public or private. A decentralized computing system, similar to traditional banking systems, allows for transferring and investing of the digital assets. Although cryptocurrency has been a hot topic for years, many users find engagement with such platforms complicated and overly burdensome to use. Even with the introduction of a physical card such as Ballet, which is a metal card having a QR code associated with a cryptocurrency wallet address, users are still unable to use their cryptocurrencies as they are accustomed to with traditional currency. Complex steps must be taken before a user can submit a simple transfer of one type of cryptocurrency to or from a different type of currency, whether digital or traditional.

Accordingly, needs exist for a straightforward and simplified system for allowing users to access their cryptocurrency accounts and transfer or invest the balance of these digital assets between various cryptocurrency exchange platforms and traditional currency exchange platforms without the need for complex, intermediary steps or additional exchange platforms.

### BRIEF SUMMARY

Embodiments of the present invention address the above needs and/or achieve other advantages by providing systems and methods that receive a request for web-based browser or dedicated application interaction associated with an entity with which a user holds at least one account associated with a traditional resource system. The system receives login credentials and a request for remote access to the at least one account from a user device over the Internet. The system then authenticates the login credentials in order to authorize remote access to the user device. Next, the system receives a unique identifier for an electronic digital certificate associated with at least one distributed ledger technology of a user from the user device. The electronic digital certificate is generally a first type of resource or asset. The system stores a record of the unique identifier for the electronic digital certificate. A request is received to initiate an interaction between the at least one distributed ledger technology and the at least one account. The system determines, based on the record of the unique identifier, a quantity of the first type of resource associated with the electronic digital certificate. A request is then received to initiate an interaction between the at least a portion of the first type of resource and the at least one account based on the quantity of the at least a portion of the first type of resource. The system transforms the at least a portion of the first type of resource into a second type of resource compatible with the at least one account. After transforming the portion of the first type of resource, the system completes the interaction between the distributed ledger technology and the at least one account.

According to embodiments of the invention, a system for transforming a resource includes at least one processor, a communication interface communicatively coupled to the at least one processor and configured to communicate over at least one network with one or more additional sets of processors, each processor associated with at least a first distributed resource system, and a memory storing executable code. When executed, the code causes the processor to receive a request for web-based browser or dedicated application interaction associated with an entity with which a user holds at least one account associated with a traditional resource system. The system receives login credentials and a request for remote user access to the at least one account from a user device over the Internet. The system authenticates the login credentials, and if the authentication is successful or confirmed, the system generates and transmits a user authentication confirmation over the Internet to the user device. With the authentication, the system grants the user device remote user access over the Internet. Once access is granted, the system receives a unique identifier for an electronic digital certificate associated with at least one distributed ledger technology of a user from the user device. The electronic digital certificate comprises a first type of resource. The system stores a record of the unique identifier for the electronic digital certificate for later access by the user via the user device. At some point, the system receives a request to initiate an interaction between the at least one distributed ledger technology and the at least one account. The system determines, based on the stored record of the unique identifier, a quantity for the first type of resource associated with the electronic digital certificate. From the user device, the system receives a request to initiate an interaction between at least a portion of the first type of resource and the at least one account. The system transforms the portion of the first type of resource into a second type of resource compatible with the at least one account. In response to transforming the portion of the first type of resource into a second type of resource, the system completes the interaction between the at least one distributed ledger and the at least one account.

According to example embodiments of the invention, a method for transforming a resource includes receiving, via a network, a request for web-based browser or dedicated application interaction associated with an entity with which a user holds at least one account associated with a centralized system. The method involves (1) receiving, from a user device over the Internet, login credentials and a request for remote user access to the at least one account; (2) performing, via the network, authentication of the login credentials; (3) generating and transmitting, via the network, a user authentication confirmation over the Internet to the user device; (4) granting, via the network, remote user access over the Internet to the user device. The method further involves: (1) receiving, from the user device, a unique identifier for an electronic digital certificate associated with at least one distributed ledger technology, wherein the electronic digital certificate is a digital resource; (2) registering in memory a record of the unique identifier; (3) receiving from the user device a request to initiate an interaction between the at least one distributed ledger technology and the at least one account; (4) determining based on the stored record of the unique identifier, a quantity of the digital resource; (5) receiving a request based on the quantity of the digital resource, a request to complete the interaction between the distributed ledger technology and the at least one account; (6) transforming the digital resource into a non-digital resource compatible with the at least one account; and (7) in response to transforming the digital resource into a non-digital resource, completing the interaction between the at least one distributed ledger technology and the at least one account.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an enterprise system and environment thereof for cross functionality of crypto interactions by transforming resources between centralized and decentralized networks, in accordance with an embodiment of the present invention;

FIG. 2A is a flowchart illustrating a method for transforming a distributed resource to a traditional resource, according to at least one embodiment.

FIG. 2B is a continuation of the flowchart of FIG. 2A.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

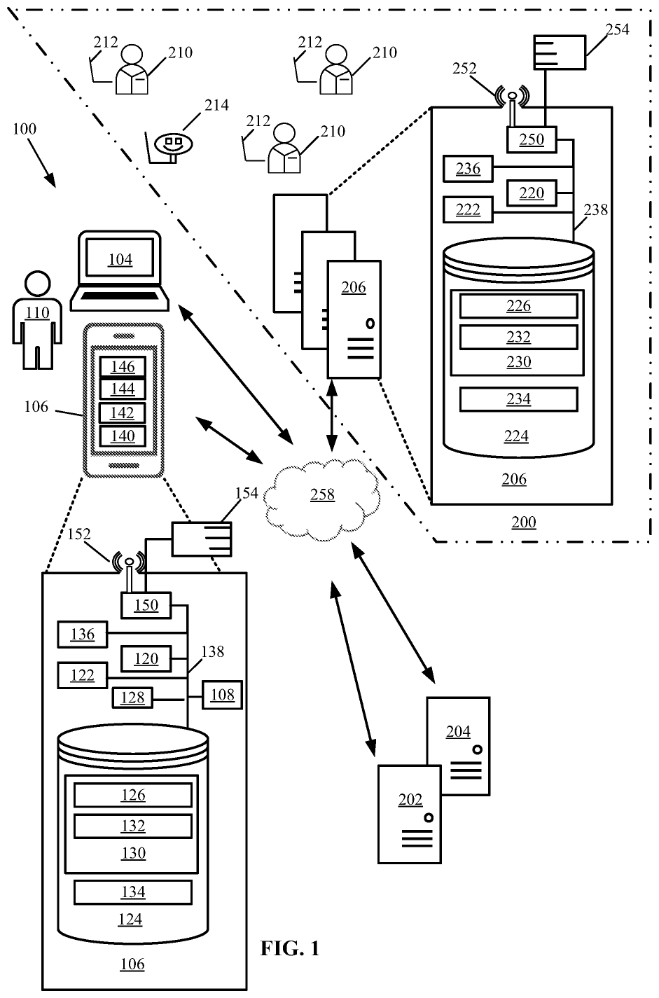

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)— with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, laaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

In example embodiments, various systems, methods, and computer products provide a user with the ability to initiate a transaction, or interaction, between a cryptocurrency network and a traditional user account such as a bank account. The term “cryptocurrency” may be used interchangeably herein with “crypto,” “blockchain,” “hashgraph,” “distributed resource,” “distributed ledger,” or “electronic digital certificate.” Electronic digital certificates may either be fungible (interchangeable with another token) or non-fungible (completely unique, and therefore not interchangeable with another token).

In various embodiments, the system allows a user to easily transfer assets from their cryptowallet to their bank account without having to first sell or convert the cryptocurrency on a cryptocurrency exchange platform and then deposit the proceeds into a bank account. As a further example, the system also works in the reverse scenario by allowing a user to easily transfer assets from their bank account to their cryptowallet without having to first convert the U.S. Dollar or other currency into a cryptocurrency on a crypto exchange. Thus, the system allows for easy and fast transactions between a bank account and a cryptowallet.

As is well understood, traditional currency, also known as fiat money, is a type of currency or resource that can be used directly, in-person or indirectly, over the Internet. Traditional currency is backed by a government entity or centralized system such as the US Federal Reserve. Conversely, cryptocurrency or an electronic digital certificate, is a form of currency that is configured to facilitate currency exchanges on a computer network, without the need for a central authority, such as a government or bank. Thus, the cryptocurrency system is a decentralized system or network and may be referred to as a decentralized electronic ledger. Although discussed in the context of a decentralized system, cryptocurrency can also be used in other systems including in a centralized network, hybrid network, or P2P network that maintains the anonymity of the user. The distributed ledger technology, or DLT, allows for the storage of information in a secure and accurate manner using cryptography techniques that utilize cryptographic signatures and keys. When the info or data is stored using the DLT protocol, it becomes an immutable database governed by the rules of the network. In practice, centralized systems and decentralized networks exist separately from each other and require different parameters and protocols for transactions/interactions such as exchanges or transfers.

The cryptocurrency system may be suitable for use with any electronic digital certificate such as Bitcoin, Ethereum, Tether, Binance USD, Dogecoin, Cardano, Solana, Polygon, Polkadot, SHIBA INU, Dai, Avalanche, Uniswap, Wrapped Bitcoin, Litecoin, Chainlink, Cosmos, Ethereum Classic, Algorand, Crypto.com Coin, Stellar Lumens, NEAR Protocol, Bitcoin Cash, Quant, Filecoin, Flow, Chilliz, ApeCoin, Internet Computer, Hedera, Tezos, The Sandbox, Aave, Decentraland, EOS, Chain, Paxos Standard, Axie Infinity, Aptos, BitDAO, Synthetix Network Token, Maker, Zcash, Gemini Dollar, The Graph, Mina, Curve DAO Token, DASH, BNB, USD Coin, XRP, etc. The electronic digital certificate, or cryptocurrency, may be stored on a blockchain, hashgraph, distributed resource, or distributed ledger. For example, an electronic digital certificate such as Bitcoin is stored on a blockchain and includes a record, a hash, and the hash of the previous block. A hash is comparable to a person's fingerprint in that each hash is unique. A hash is a 256-bit number (e.g., SHA256 hash algorithm) or hexadecimal value that uses the letters A-F as well as the digits 0-9 to represent a number. Any other identifying form of a hash may be used.

Ownership of the cryptocurrency is established through digital keys, digital/virtual addresses, and digital signatures. Every crypto transaction requires a valid digital signature for the transaction to be incorporated onto the blockchain or hashgraph. A digital signature can only be generated with a valid digital key. The digital keys use a public key cryptographic method that includes a private key and a public key. The combination of the pair of keys is known as a crypto address, or unique identifier, that may be used within the decentralized computing platform to receive or transfer a digital bearer asset. For example, a public key is comparable to a traditional bank account number and a private key is comparable to a PIN, where the crypto address is a combination of the two that allows a user to access their cryptocurrency accounts to receive or transfer assets in the account. In example embodiments, the public key is used to receive the cryptocurrency and the private key is used to apply the digital signature to transfer or spend the cryptocurrency. In some embodiments, the opposite may also be true.

The digital keys may be created and stored by a user in a file or database called a wallet or cryptowallet that provides an interface that lets a user access their cryptocurrency. There are several types of wallets including, but not limited to, (1) web wallets that facilitate transactions through a web browser; (2) desktop wallets that store private keys on a computer hard drive; (3) mobile wallets that use QR codes or other unique identifiers and a mobile app to facilitate a cryptocurrency transaction; (4) hardware wallets that use the bare minimum amount of software to store cryptocurrency; (5) paper wallets similar to a printed bank note; and (6) brain wallets that implement a passphrase to access and store a cryptocurrency. A physical paper wallet is beneficial because it provides a user with an offline backup of their cryptocurrencies. With a paper wallet, a public and private key can be generated offline and not stored on a computer system, which may be susceptible to hackers, key-loggers, or other online computer threats. Thus, the keys in the user's wallet can be generated and managed by local software independent of the bitcoin or crypto protocol and without reference to the blockchain or access to the Internet.

However, a simple paper wallet may still be susceptible to theft, so a more sophisticated approach is to use a form of encryption such as BIP0038 encryption for the wallet. For example, the pair of keys on the wallet are protected by a passphrase known only by the owner of the wallet, as is used with a “brain wallet.” Without the passphrase, the encrypted keys are useless. The cryptowallet may also be incorporated into a physical card, similar to a credit card that is less vulnerable to loss or damage than a paper wallet. The physical card may include a QR code or unique ID associated with the cryptowallet. Like paper wallets, a physical card allows a user to store native cryptocurrencies from various crypto exchange networks in a single wallet. The cryptowallet may also include two-or-multi-factor authentication or two-or-multi-factor private keys to enhance the security of the cryptowallet. However, as with traditional currency, if a user loses the physical card, then the user also loses the assets.

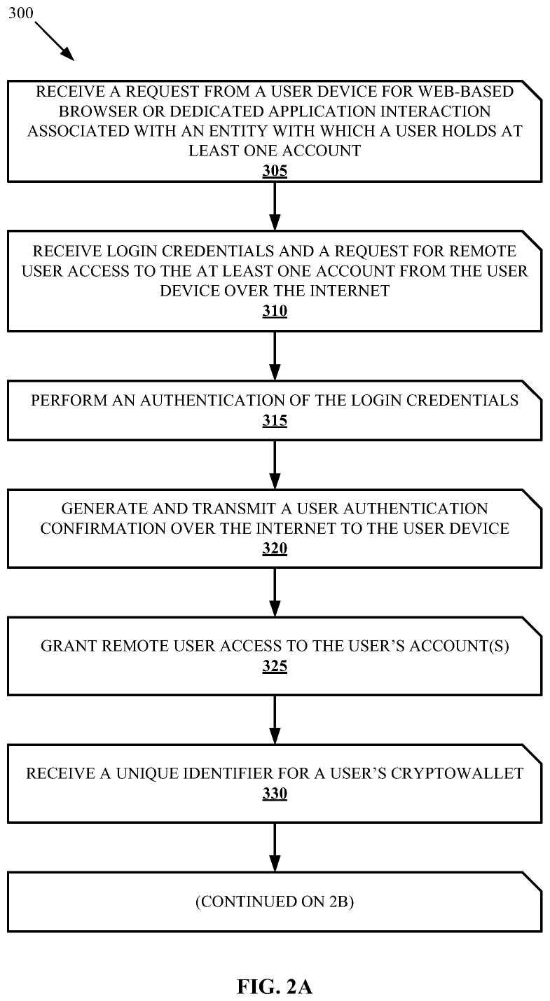

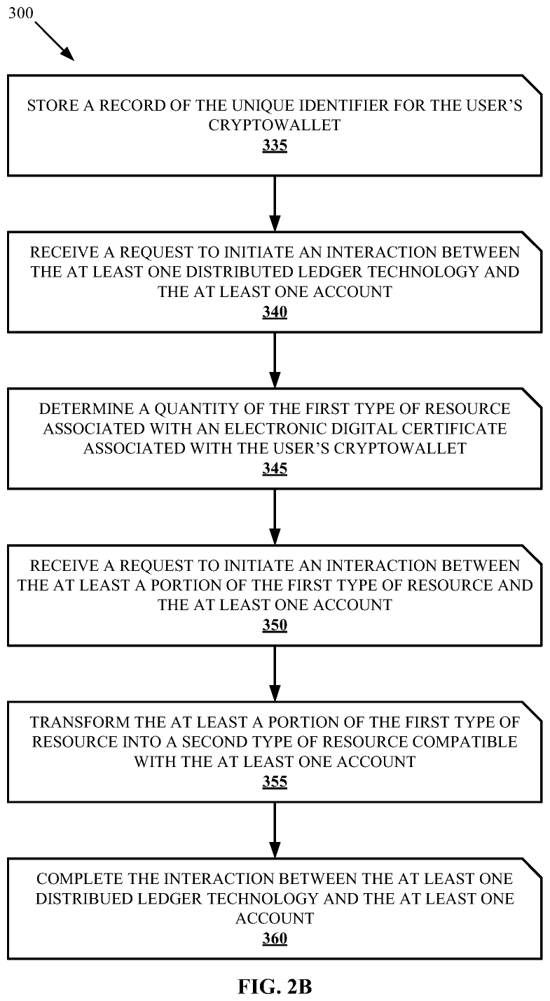

FIGS. 2A-2B depict a flow chart representing a method 300, according to at least one embodiment, for initiating an exchange or interaction between a decentralized, cryptocurrency system and a centralized system such as a bank account. The method is performed by a system that includes at least one processor and a communication interface communicatively coupled to the at least one processor and configured to communicate over at least one network with one or more additional sets of processors, each set of processors being associated with at least a first distributed resource system. As described above, a distributed resource system is a cryptocurrency platform that facilitates the buying, selling, and trading of cryptocurrency. Crypto exchanges also permit a user to convert cryptocurrencies back into a traditional currency such as the U.S. Dollar.

The first step, as represented by block 305, is to receive a request for web-based browser or dedicated application interaction associated with an entity with which a user holds at least one account from a user device. In example embodiments, the at least one account is a user's bank account associated with a traditional resource or banking system. The user device, which may be a mobile device or non-mobile device, communicates with a back-end server system associated with the user account. The web-based browser is navigated to the online banking platform for the entity when it is a bank. The dedicated application may be a mobile application downloaded from an app store or other application hub for mobile devices.

Next, at step 310, the system receives login credentials and a request for remote user access to the at least one account from a user device over the Internet. The user device may receive input from the user supplying the login credentials and submitting the request for remote access. The login credentials correspond to a basic level of remote user access to the user's account(s) and may include a username and password or other basic credentials. The request may be initiated by the back-end server system, from the web-based browser based on directions from the online banking platform (which may come from a back-end server system or another entity system), or from the dedicated mobile app. The login credentials may be received after a user is presented with a pop-up window or online in the application or web-site content. The system may receive the login credentials after a user attempts to navigate to information, such as account information, that is confidential and only disclosed upon user authentication. In some embodiments, the system requests and receives multi-factor authentication credentials from the user device.

The next step, as represented by block 315, is to perform an authentication of the login credentials. The login credentials are transmitted over the Internet to an entity server requesting authentication of the login credentials. The system then authenticates the login credentials.

At block 320, in response to successful authentication of the login credentials, the system generates and transmits a user authentication confirmation over the Internet to the user device. Based on the authentication confirmation, the system, at block 325, grants remote user access to the user's account(s) over the Internet to the user device.

Once the user device has been granted remote user access, the system receives, at block 330, a unique identifier or address for a cryptowallet owned or controlled by a user. The cryptowallet includes data relating to one or more electronic digital certificates associated with at least one DLT from the user device. The DLT includes information relating to a first type of digital resource or electronic digital certificate. For example, the information regarding the digital resource may include balance information, transaction data information, and trade history information. In example embodiments, the unique identifier or address includes a crypto address that serves as a virtual location of where the user's electronic digital certificate(s) is/are stored and where additional electronic digital certificates may be sent within the decentralized computing platform. Thus, the crypto address is used within the decentralized computing platform to receive or transfer a digital bearer asset. The distributed ledger technology may be any suitable cryptocurrency platform or exchange, as described above. In example embodiments, the first type of resource is a cryptocurrency such as Bitcoin, Ethereum, Tether, BNB, USD Coin, XRP, Binance USD, Cardano, Solana, Dogecoin, Polygon, Polkadot, etc.

While an address for an electronic digital certificate is different than a cryptowallet in that it cannot hold a balance, the address does provide the system with information pertaining to the balance of the particular type of resource on the crypto exchange, similar to a cryptowallet. The address generally consists of a string of 26-35 alphanumeric characters that is generated through cryptographic operations, where a private key is generated through an asymmetric signature algorithm and then a public key is derived from the private key. A user may sign with the private key and verify that signature with the public key. The address may be used to represent a cryptowallet or ballet (e.g., bitcoin wallet) that can send and receive cryptocurrency.

At step 335, after receiving the unique identifier, the system stores a record of the unique identifier for the cryptowallet having one or more electronic digital certificates. This unique identifier may be stored in an associated memory device and/or storage device of the system (e.g., memory device 122).

The next step, as represented by block 340, is to receive a request to initiate an interaction between the at least one distributed ledger technology and the at least one account. In various embodiments, the requested interaction is a request to transfer assets between the cryptowallet and the user account. In some embodiments, the request is to transfer at least a portion of a cryptocurrency balance to the user account. In other embodiments, the request is to transfer at least a portion of a traditional currency balance to the cryptocurrency balance on the cryptowallet associated with the distributed ledger. In particular embodiments, the request to initiate the interaction includes a second authentication process for authenticating the user on the crypto network.

At step 345, the system determines, based on the stored record of the unique identifier for the electronic digital certificate, a quantity of the first type of resource associated with the electronic digital certificate. In example embodiments, the quantity will be a number, price, or amount of cryptocurrency that the user currently has in their cryptowallet. For example, the system may determine that a user currently has 2 Bitcoins stored in their cryptowallet.

At block 350, the system receives a request, based on the quantity of the first type of resource, to initiate an interaction between at least a portion of the first type of resource, or cryptocurrency, and the at least one account. In example embodiments, the request to initiate an interaction is a request to transfer a portion of the crypto balance to the user's bank account. For example, where a user has 2 Bitcoins, the system may receive a request from the user device to transfer 1 Bitcoin to the user's bank account. The quantity of the first type of resource generally includes the amount or balance of the cryptocurrency in the user's cryptowallet. In some embodiments, the request may be to send the entire balance of the cryptowallet to the user's bank account, without specifically stating the quantity. For example, if the user currently has 0.00056789 BTC, the user may simply specify that they wish to transfer the full balance, rather than entering the total amount of BTC in their cryptowallet.

At block 355, the portion of the first type of resource is transformed into a second type of resource that is compatible with the at least one account. For example, if the first type of resource is Bitcoin, then the system will transform or convert the Bitcoin into the second type of resource, such as USD, on the back-end server through communication with the Bitcoin exchange. This conversion will be based on the current market prices for that particular cryptocurrency. Conversely, the first type of resource may be a traditional form of currency that the user desires to convert to a cryptocurrency.

Once the transformation or conversion has occurred, as represented by block 360, the system completes the interaction between the distributed ledger technology and the user account. The interaction may be any suitable transaction including buying, selling, or trading cryptocurrency. For example, a user may initiate an interaction to exchange at least a portion of the balance of their Bitcoin on their cryptowallet for U.S. dollars to be deposited into their bank account. Rather than having to go to a cryptowallet network application to make the exchange on the Bitcoin network from BTC to USD and then transfer the USD balance to their bank account, costing the user time and money, the user is able to complete the transaction in a single step on their bank account web-based browser or dedicated mobile app.

What is claimed is:

1. A method for transforming a resource, the method comprising:
receiving a request for web-based browser or dedicated application interaction associated with an entity with which a user holds at least one account associated with a traditional resource system;
receiving login credentials and a request for remote user access to the at least one account from a user device over the Internet;
authenticating the login credentials;
in response to authenticating the login credentials, authorizing remote user access to the user device over the Internet;
receiving a unique identifier for an electronic digital certificate associated with at least one distributed ledger technology of a user from the user device, wherein the electronic digital certificate comprises a first type of resource;
storing a record of the unique identifier for the electronic digital certificate;
receiving a request to initiate an interaction between the at least one distributed ledger technology and the at least one account;
determining, based on the record of the unique identifier, a quantity of the first type of resource associated with the electronic digital certificate;
receiving a request to initiate an interaction between the at least a portion of the first type of resource associated with the electronic digital certificate and the at least one account based on the quantity of the at least a portion of the first type of resource;
transforming the at least a portion of the first type of resource into a second type of resource compatible with the at least one account;
in response to transforming the at least a portion of the first type of resource into a second type of resource, completing the interaction between the at least one distributed ledger technology and the at least one account.

2. The method of claim 1, wherein the entity comprises a bank and the at least one account comprises a bank account.

3. The method of claim 1, wherein the first type of resource is a digital asset.

4. The method of claim 3, wherein the digital asset is a cryptocurrency selected from a group consisting of: Bitcoin, Ethereum, Tether, Binance USD, Dogecoin, Cardano, Solana, Polygon, Polkadot, SHIBA INU, Dai, Avalanche, Uniswap, Wrapped Bitcoin, Litecoin, Chainlink, Cosmos, Ethereum Classic, Algorand, Crypto.com Coin, Stellar Lumens, NEAR Protocol, Bitcoin Cash, Quant, Filecoin, Flow, Chilliz, ApeCoin, Internet Computer, Hedera, Tezos, The Sandbox, Aave, Decentraland, EOS, Chain, Paxos Standard, Axie Infinity, Aptos, BitDAO, Synthetix Network Token, Maker, Zcash, Gemini Dollar, The Graph, Mina, Curve DAO Token, and DASH.

5. The method of claim 1, wherein the second type of resource is a traditional asset maintained, stored, or controlled by a centralized system.

6. The method of claim 1, wherein the unique identifier comprises an address on a blockchain for a cryptowallet.

7. The method of claim 6, wherein the cryptowallet stores one or more private keys and/or one or more public keys to send, receive, and spend the first type of resource.

8. The method of claim 1, wherein the request to initiate an interaction between the at least one distributed ledger technology and the at least one account comprises an interaction selected from the group consisting of selling, buying, and trading.

9. The method of claim 1, wherein the method further comprises:
receiving the unique identifier for the electronic digital certificate associated with at least one distributed ledger technology of a user from the user device, wherein the electronic digital certificate comprises a third type of resource;
storing a record of the unique identifier for the electronic digital certificate;
receiving a request to initiate an interaction between the at least one distributed ledger technology and the at least one account;
determining, based on the record of the unique identifier, a quantity of the third type of resource associated with the electronic digital certificate;
receiving a request to initiate an interaction between the at least a portion of the third type of resource associated with the electronic digital certificate and the at least one account based on the quantity of the at least a portion of the third type of resource;
transforming the at least a portion of the third type of resource into the second type of resource compatible with the at least one account;
in response to transforming the at least a portion of the third type of resource into the second type of resource, completing the interaction between the at least one distributed ledger technology and the at least one account.

10. A system for transforming a resource, the system comprising:
at least one processor;
a communication interface communicatively coupled to the at least one processor and configured to communicate over at least one network with one or more additional sets of processors, each processor associated with at least a first distributed resource system; and
a memory device storing executable code that, when executed, causes the processor to:
receive a request for web-based browser or dedicated application interaction associated with an entity with which a user holds at least one account associated with a traditional resource system;
receive login credentials and a request for remote user access to the at least one account from a user device over the Internet;
perform authentication of the login credentials;
in response to successful authentication of the login credentials, generate and transmit a user authentication confirmation over the Internet to the user device;
grant remote user access over the Internet to the user device;
receive a unique identifier for an electronic digital certificate associated with at least one distributed ledger technology of a user from the user device, wherein the electronic digital certificate comprises a first type of resource;
store a record of the unique identifier for the electronic digital certificate;
receive a request to initiate an interaction between the at least one distributed ledger technology and the at least one account;
determine, based on the record of the unique identifier for the electronic digital certificate, a quantity of the first type of resource associated with the electronic digital certificate;
receive a request, based on the quantity of at least a portion of the first type of resource, to initiate an interaction between the at least a portion of the first type of resource associated with the electronic digital certificate and the at least one account;
transform the at least a portion of the first type of resource into a second type of resource compatible with the at least one account;
in response to transforming the at least a portion of the first type of resource into a second type of resource, complete the interaction between the at least one distributed ledger technology and the at least one account.

11. The system of claim 10, wherein the entity comprises a bank and the at least one account comprises a bank account.

12. The system of claim 10, wherein the unique identifier comprises a cryptowallet that stores one or more private keys and/or one or more public keys to send, receive, and spend the first type of resource.

13. The system of claim 10, wherein the request to initiate an interaction between the at least one distributed ledger technology and the at least one account comprises an interaction selected from the group consisting of selling, buying, and trading.

14. The system of claim 10, wherein the first type of resource is an electronic asset maintained or stored on a decentralized network and the second type of resource is a traditional asset maintained, stored, or controlled by a centralized system.

15. The system of claim 14, wherein the electronic asset is authenticated by a blockchain network.

16. A method for transforming a resource, the method comprising:
receiving, via a network, a request for web-based browser or dedicated application interaction associated with an entity with which a user holds at least one account associated with a centralized system;
receiving, from a user device over the Internet, login credentials and a request for remote user access to the at least one account;
performing, via the network, authentication of the login credentials;
generating and transmitting, via the network, a user authentication confirmation over the Internet to the user device;
granting, via the network, remote user access over the Internet to the user device;
receiving, over the Internet from the user device, a unique identifier for an electronic digital certificate associated with at least one distributed ledger technology, wherein the electronic digital certificate comprises a digital resource;
registering in memory a record of the unique identifier for the electronic digital certificate;
receiving, over the Internet from the user device, a request to initiate an interaction between the at least one distributed ledger technology and the at least one account;
determining, based on the record of the unique identifier for the electronic digital certificate stored in memory, a quantity of the digital resource;
receiving, over the Internet from the user device, a request, based on the quantity of the digital resource, to complete the interaction between the distributed ledger technology and the at least one account;
transforming, on a back-end server, the digital resource into a non-digital resource compatible with the at least one account;
in response to transforming the digital resource into a non-digital resource compatible with the at least one account, completing the interaction between the at least one distributed ledger technology and the at least one account.

17. The method of claim 16, wherein the entity comprises a bank and the at least one account comprises a bank account.

18. The method of claim 16, wherein the unique identifier comprises a cryptowallet that stores one or more private keys and/or one or more public keys to send, receive, and spend the digital resource.

19. The method of claim 16, the method further comprising:
determining, based on the record of the unique identifier for the electronic digital certificate stored in memory, at least a portion of the quantity of the digital resource;
receiving, over the Internet from the user device, a request, based on the at least a portion of the quantity of the digital resource, to complete the interaction using the at least a portion of the quantity of the digital resource between the distributed ledger technology and the at least one account;
transforming, on a back-end server, the at least a portion of the digital resource into a non-digital resource compatible with the at least one account;
in response to transforming the at least a portion of the digital resource into a non-digital resource compatible with the at least one account, completing the interaction between the at least one distributed ledger technology and the at least one account.

20. The method of claim 16, wherein the request to initiate an interaction between the at least one distributed ledger technology and the at least one account comprises an interaction selected from the group consisting of selling, buying, and trading.
